(19) United States
(12) Patent Application Publication
(10) Pub. No.: US 2025/0044101 A1
(43) Pub. Date: Feb. 6, 2025

(54) MEASUREMENT ROUTE DESIGN METHOD, MEASUREMENT ROUTE DESIGN APPARATUS AND NON-TRANSITORY COMPUTER-READABLE REACORDING MEDIUM STORING PROGRAM

(71) Applicant: NIPPON TELEGRAPH AND TELEPHONE CORPORATION, Tokyo (JP)

(72) Inventors: Kotaro MATSUDA, Tokyo (JP); Yosuke TAKAHASHI, Tokyo (JP); Hiroki IKEUCHI, Tokyo (JP)

(21) Appl. No.: 18/723,614

(22) PCT Filed: Feb. 25, 2022
(86) PCT No.: PCT/JP2022/007920

§ 371 Date: Jun. 24, 2024

(51) Int. Cl. G01C 21/20; H04W 24/10

(52) U.S. Cl. CPC G01C 21/20; H04W 24/10

(57) ABSTRACT

A computer executes a collection procedure of collecting first measurement information measured by passive measurement, a communication status estimation procedure of estimating an estimation map representing a communication status of each position using the first measurement information, and a design procedure of designing a measurement route of active measurement using the estimation map.

### TECHNICAL FIELD

The present disclosure relates to a measurement route design method, a measurement route design apparatus and a program.

### BACKGROUND ART

Techniques for detecting deterioration of a communication status based on data collected in a real space are classified into two types: a technique based on passive measurement and a technique based on active measurement.

Passive measurement is a method of collecting measurement information called a communication status report or the like from user terminals discretely distributed in a real space. As an existing method for detecting deterioration of a communication status based on the passive measurement, for example, there is a method described in Non Patent Literature 1. On the other hand, active measurement is a method in which a communication company collects measurement information by dispatching a vehicle, an unmanned aerial vehicle (UAV), or the like equipped with a measuring instrument and measuring a communication status on site. There are many methods for estimating a certain state based on active measurement in the field of sensing, and for example, Non Patent Literature 2 describes a method related to shape estimation using a measurement robot. Note that the measurement information collected by passive measurement or active measurement includes, for example, information such as a measurement position, a measurement date and time, a communication cell ID, and radio field intensity.

Incidentally, in recent years, densification of a wireless network and use of a high frequency band have progressed, and there is a concern about an increase in communication degradation area due to an increase in the number of failures accompanying an increase in the number of base stations, an increase in the effects of a shielding object, and the like. In addition, at this time, there is a concern that communication degradation that becomes severe with the elapse of time will increase in a local range (for example, about 10 m to 100 m) due to a base station failure and the effects of a shielding object.

### CITATION LIST

### Non Patent Literature

Non Patent Literature 1: F. Sohrabi and E. Kuehn, “Construction of the RSRP map using sparse MDT measurements by regression clustering,” Proceedings of 2017 IEEE International Conference on Communications, pp. 1-6, May 2017.
Non Patent Literature 2: I. Abraham, A. Prabhakar, M. J. Z. Hartmann and T. D. Murphey, “Ergodic Exploration Using Binary Sensing for Nonparametric Shape Estimation,” IEEE Robotics and Automation Letters, vol. 2, no. 2, pp. 827-834, April 2017.

### SUMMARY OF INVENTION

### Technical Problem

However, in the existing method based on passive measurement, it is considered that it is difficult to detect deterioration of a communication status. This is because the radius of the communication cell decreases due to the increase in density of the wireless network, so that the number of pieces of measurement information per cell decreases, and as a result, an area in which the amount of measurement information necessary for detecting the deterioration of the communication status cannot be collected may occur.

On the other hand, since active measurement is generally expensive, it is often practically difficult to collect measurement information exhaustively from a wide area where deterioration of a communication status is desired to be detected. In addition, since suspected locations of communication degradation are scattered in the real space, it is difficult to determine effective measurement positions, routes, and the like to be subjected to the active measurement at low cost even by human labor based on know-how and the like.

The present disclosure has been made in view of the above points, and provides a technique for efficiently detecting communication degradation.

### Solution to Problem

In a measurement route design method according to an aspect of the present disclosure, a computer executes a collection procedure of collecting first measurement information measured by passive measurement; a communication status estimation procedure of estimating an estimation map representing a communication status at each position using the first measurement information; and a design procedure of designing a measurement route of active measurement using the estimation map.

### Advantageous Effects of Invention

According to the present disclosure, there is provided a technique for efficiently detecting communication degradation.

### BRIEF DESCRIPTION OF DRAWINGS

FIG. 1 is a diagram illustrating an example of an overall configuration of a communication degradation detection system according to the present embodiment.

FIG. 2 is a diagram illustrating an example of a hardware configuration of a communication degradation detection device according to the present embodiment.

FIG. 3 is a diagram illustrating an example of a functional configuration of a communication degradation detection device according to the present embodiment.

FIG. 4 is a flowchart illustrating an example of passive measurement information collection processing.

FIG. 5 is a flowchart (first embodiment) illustrating an example of measurement route design and active measurement processing.

FIG. 6 is a flowchart (second embodiment) illustrating an example of measurement route design and active measurement processing.

FIG. 7 is a flowchart illustrating an example of communication degradation detection processing.

### DESCRIPTION OF EMBODIMENTS

Hereinafter, an embodiment of the present invention will be described. Hereinafter, a communication degradation detection system 1 capable of efficiently detecting communication degradation mainly for a high-density wireless network (that is, a radio network in which base stations are densely disposed and a radius of a communication cell is relatively small) will be described.

In order to efficiently detect communication degradation, in the present embodiment, use of both measurement information collected by passive measurement and measurement information collected by active measurement for communication degradation detection by combining the passive measurement and the active measurement will be studied. In general, the measurement position of the passive measurement depends on the position of the user terminal and thus cannot be controlled. However, since measurement can be performed at an arbitrary position in the active measurement, complementary use of the measurement information collected by the active measurement with respect to the measurement information collected by the passive measurement will be studied. This is because, in a case where the entire area where communication degradation is desired to be detected is measured by the active measurement, a large cost is generally incurred, but it is considered that measurement information capable of detecting communication degradation in the entire area can be collected within a limited cost if only an effective position that complements the measurement information collected by the passive measurement (for example, a position or the like in a region where measurement information collected by the passive measurement is sparse) is selected and the active measurement is performed at the position. Hereinafter, the measurement information collected by the passive measurement is also referred to as “passive measurement information”, and the measurement information collected by the active measurement is also referred to as “active measurement information”. On the other hand, in a case where the “passive measurement information” and the “active measurement information” are not distinguished or in a case where it is obvious from the context which measurement information is mentioned, they are simply referred to as “measurement information”.

As an existing method of the passive measurement, for example, a method called minimization of drive test (MDT) is known. In addition, as an existing method for detecting deterioration of a communication status based on the passive measurement, a method described in Non Patent Literature 1 described above and various other methods are known. Many of these conventional techniques use a spatial complement technique called kriging. In addition, there is also a method of estimating a failure of a base station using deep learning, and the like.

On the other hand, there are many existing methods of the active measurement in the field of sensing, and the method described in Non Patent Literature 2 mentioned above and various other methods are known.

### <Outline of Communication Degradation Detection>

In the present embodiment, the communication degradation area is detected by the following six steps.

Step 1. Collect passive measurement information from a user terminal.

Step 2. Estimate the communication status of each position using the collected measurement information, and create an estimation map representing the estimation result.

Step 3. Design a measurement route of active measurement from the estimation map obtained in Step 2 described above.

Step 4. Perform the active measurement according to the measurement route designed in Step 3 described above, and collect active measurement information.

Step 5. End the active measurement and proceed to Step 6 in a case where the upper limit of the cost constraint such as the number of times of measurement of the active measurement is satisfied. Otherwise, return to Step 2 and create the estimation map again.

Step 6. Create an estimation map of a communication status using measurement information collected by the passive measurement and the active measurement, and compare the estimation map with an originally expected communication status to detect a communication degradation area.

At this time, in Step 3 described above, a measurement route of the active measurement is designed by Bayesian optimization. That is, after the communication status is estimated by the Gaussian process in the above-described Step 2, a measurement route for optimizing a predetermined acquisition function is designed using the estimation result and the predetermined acquisition function in the above-described Step 3. Note that, in Step 6 described above, similarly to Step 3, the estimation map is created by estimating the communication status by the Gaussian process.

### <Problem Setting and Solving Method Therefor>

Problem setting of the present embodiment and a method for solving the problem will be described.

A problem is considered in which the active measurement in which a probability of overlooking communication degradation when communication degradation occurs is the smallest is defined as optimal active measurement, and optimal active measurement satisfying a predetermined constraint condition is sequentially obtained under a condition that the passive measurement information is given.

In addition, a point where the radio field intensity of a radio wave from a certain base station is smaller than a value expected at the time of design by more than a threshold is defined as a position where communication degradation occurs. As a constraint on the active measurement, a constraint regarding the number of times of the active measurement is imposed. That is, the active measurement is limited to the predetermined number of times T or less. Further, it is assumed that the active measurement is performed according to a continuous route, and a distance between two continuous measurement points is a predetermined constant value dist or less.

Since new measurement information regarding the communication status can be obtained by performing the active measurement, in the above problem setting, the next measurement position can be determined from the beginning for each measurement instead of fixing the measurement route of the active measurement at the start of measurement. That is, the measurement route of the active measurement can be sequentially designed.

In the present embodiment, a method of designing a measurement route by a heuristic algorithm using Bayesian optimization is provided as a solution to the above problem. Hereinafter, it is assumed that the communication status is the radio field intensity, and the measurement information includes at least the measurement point (measurement position) and the radio field intensity. However, the communication status is not limited to the radio field intensity, and may be other than the radio field intensity. In addition to the measurement point and the radio field intensity, the measurement information may include, for example, information such as a measurement date and time and a communication cell ID.

When the radio field intensity at each position is estimated, a Gaussian process is used. When the measurement route is designed, a measurement route that optimizes upper confidence bound (UCB) is designed using the UCB as a Monte Carlo acquisition function based on the estimated value of the radio field intensity. However, the UCB is an example, and other acquisition functions may be used. As a method of designing such a measurement route, as described below, in the present embodiment, two methods of a method based on a greedy algorithm (first embodiment) and a method using a traveling salesman problem (TSP) (second embodiment) are given.

### <Overall Configuration of Communication Degradation Detection System 1>

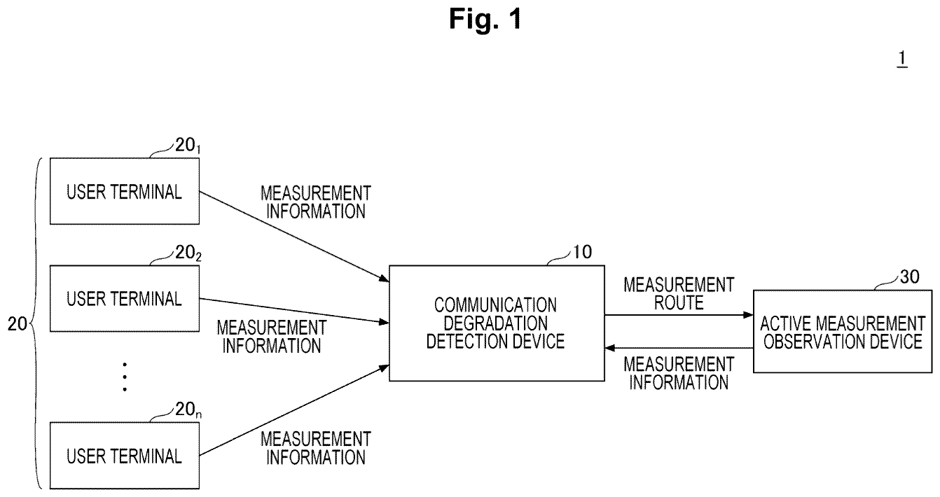

FIG. 1 illustrates an example of an overall configuration of a communication degradation detection system 1 according to the present embodiment. As illustrated in FIG. 1, the communication degradation detection system 1 according to the present embodiment includes a communication degradation detection device 10, a plurality of user terminals 20, and an active measurement observation device 30. Here, the communication degradation detection device 10 and each user terminal 20 are communicably connected via a communication network including, for example, the Internet. Similarly, the communication degradation detection device 10 and the active measurement observation device 30 are communicably connected via a communication network including, for example, the Internet.

The communication degradation detection device 10 collects the passive measurement information from each user terminal 20, sequentially designs a measurement route capable of performing optimal active measurement, and collects active measurement information measured by the active measurement from the active measurement observation device 30. The communication degradation detection device 10 detects the communication degradation area using the passive measurement information and the active measurement information.

The user terminal 20 is any of various terminals that transmit the passive measurement information to the communication degradation detection device 10. Examples of the user terminal 20 include a smartphone, a wearable device, an on-vehicle device, and the like. Note that FIG. 1 illustrates an example in which there are n user terminals 20 (user terminal 20₁, user terminal 20₂, . . . , and user terminal 20ₙ).

The active measurement observation device 30 performs active measurement according to a measurement route designed by the communication degradation detection device 10, and transmits measurement information measured by the active measurement to the communication degradation detection device 10. Examples of the active measurement observation device 30 include various vehicles (automobile, motorcycle, bicycle, and the like), a UAV (unmanned aerial vehicle, drone, and the like), a robot, an automatic driving vehicle, and the like on which a measurement device capable of measuring a communication status is mounted. However, the present invention is not limited thereto, and the active measurement observation device 30 may be, for example, a portable terminal (smartphone, tablet terminal, wearable device, and the like) on which a measurement equipment capable of measuring a communication status is mounted.

Note that the entire configuration of the communication degradation detection system 1 illustrated in FIG. 1 is an example, and the present invention is not limited thereto. For example, the communication degradation detection system 1 may include a plurality of active measurement observation devices 30.

### <Hardware Configuration of Communication Degradation Detection Device 10>

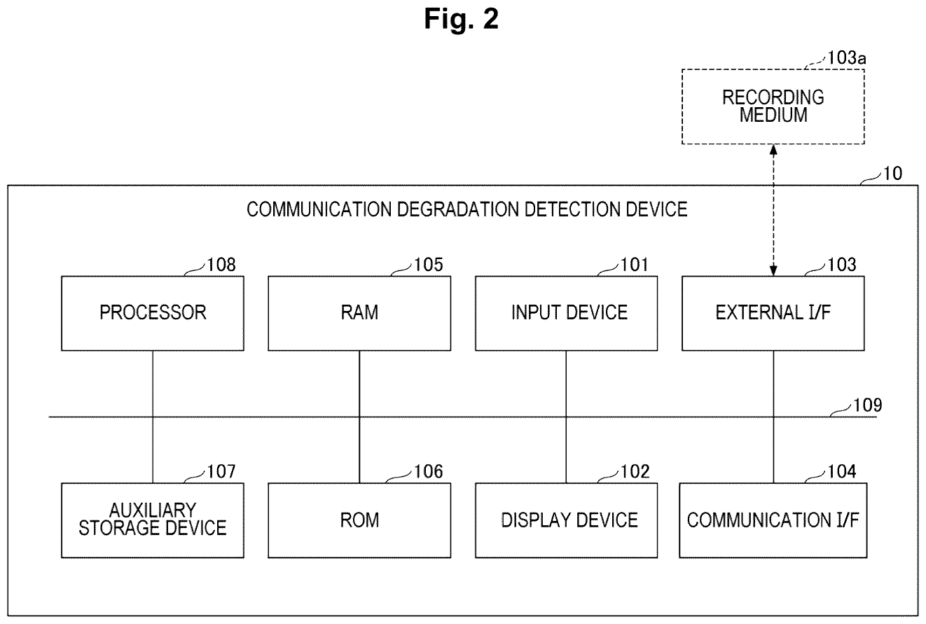

FIG. 2 illustrates a hardware configuration example of the communication degradation detection device 10 according to the present embodiment. As illustrated in FIG. 2, the communication degradation detection device 10 according to the present embodiment includes an input device 101, a display device 102, an external I/F 103, a communication I/F 104, a random access memory (RAM) 105, a read only memory (ROM) 106, an auxiliary storage device 107, and a processor 108. These pieces of hardware are communicably connected via a bus 109.

The input device 101 is, for example, a keyboard, a mouse, a touch panel, a physical button, or the like. The display device 102 is, for example, a display, a display panel, or the like. Note that the communication degradation detection device 10 does not need to include, for example, at least one selected from the input device 101 and the display device 102.

The external I/F 103 is an interface with an external device such as a recording medium 103a. Examples of the recording medium 103a include a compact disc (CD), a digital versatile disk (DVD), a secure digital memory card (SD memory card), a universal serial bus (USB) memory card, and the like.

The communication I/F 104 is an interface for connecting the communication degradation detection device 10 to a communication network. The RAM 105 is a volatile semiconductor memory (storage device) that temporarily retains programs and data. The ROM 106 is a non-volatile semiconductor memory (storage device) capable of retaining programs and data even when the power is turned off. The auxiliary storage device 107 is, for example, a non-volatile storage medium such as a hard disk drive (HDD) or a solid state drive (SSD). The processor 108 is, for example, any of various arithmetic devices such as a central processing unit (CPU) and a graphics processing unit (GPU).

Note that the hardware configuration illustrated in FIG. 2 is an example, and the communication degradation detection device 10 may have another hardware configuration. For example, the communication degradation detection device 10 may include a plurality of auxiliary storage devices 107 and a plurality of processors 108, or may include various hardware components other than the illustrated hardware components.

### <Functional Configuration of Communication Degradation Detection Device 10>

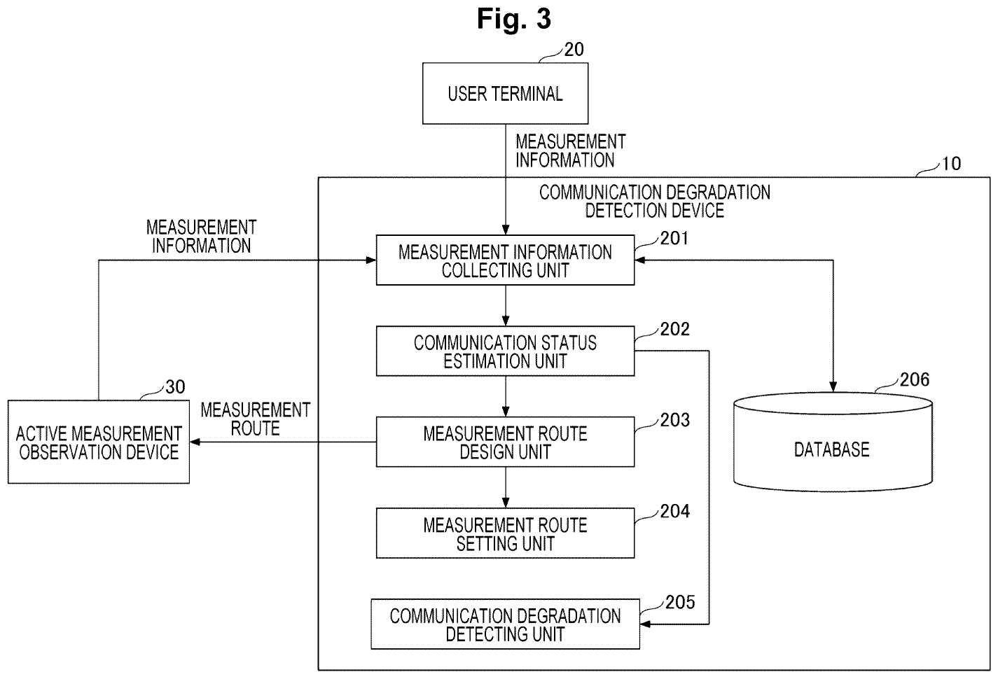

FIG. 3 illustrates a functional configuration example of the communication degradation detection device 10 according to the present embodiment. As illustrated in FIG. 3, the communication degradation detection device 10 according to the present embodiment includes a measurement information collecting unit 201, a communication status estimation unit 202, a measurement route design unit 203, a measurement route setting unit 204, and a communication degradation detecting unit 205. Each of these units is implemented, for example, by the process that one or more programs installed in the communication degradation detection device 10 causes the processor 108 or the like to execute. In addition, the communication degradation detection device 10 according to the present embodiment includes a database 206. The database 206 can be realized by, for example, the auxiliary storage device 107 or the like. Note that the database 206 may be realized by, for example, a storage device or the like connected to the communication degradation detection device 10 via a communication network.

The measurement information collecting unit 201 collects the passive measurement information from each user terminal 20. In addition, the measurement information collecting unit 201 collects the active measurement information from the active measurement observation device 30.

The communication status estimation unit 202 estimates the communication status at each position by the Gaussian process using the measurement information collected by the measurement information collecting unit 201. Note that the result of this estimation is an estimation map.

The measurement route design unit 203 uses the communication status at each position estimated by the communication status estimation unit 202 and the acquisition function to obtain a measurement route that optimizes the acquisition function. As a result, an optimal measurement route for the active measurement is designed.

The measurement route setting unit 204 sets the measurement route designed by the measurement route design unit 203 in the active measurement observation device 30. As a result, active measurement is performed by the active measurement observation device 30 according to the measurement route. However, for example, the measurement route setting unit 204 may display the measurement route on a terminal used by a driver or the like who drives the active measurement observation device 30.

The communication degradation detecting unit 205 detects the communication degradation area by comparing the communication status at each position estimated by the communication status estimation unit 202 with the originally expected communication status.

The database 206 stores the measurement information collected by the measurement information collecting unit 201.

### <Details of Processing>

Hereinafter, details of each process executed by the communication degradation detection device 10 according to the present embodiment will be described.

### <<Passive Measurement Information Collection Processing>>

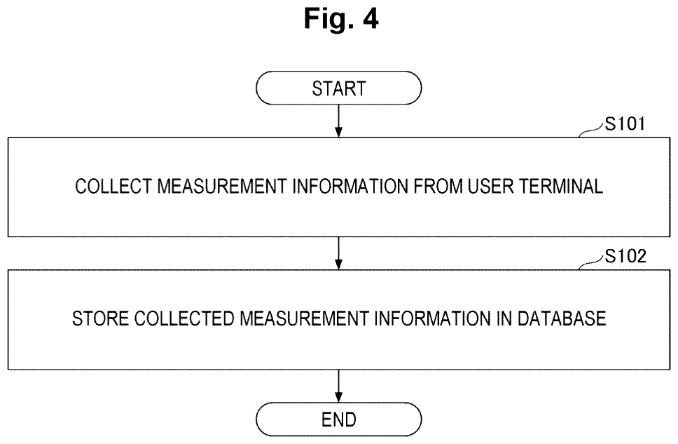

First, passive measurement information collection processing will be described with reference to FIG. 4.

The measurement information collecting unit 201 of the communication degradation detection device 10 collects the passive measurement information from each user terminal 20 (S101).

Then, the measurement information collecting unit 201 of the communication degradation detection device 10 stores the passive measurement information collected in the above-described S101 in the database 206 (S102).

### Design of Measurement Route and Active Measurement Process (First Embodiment)

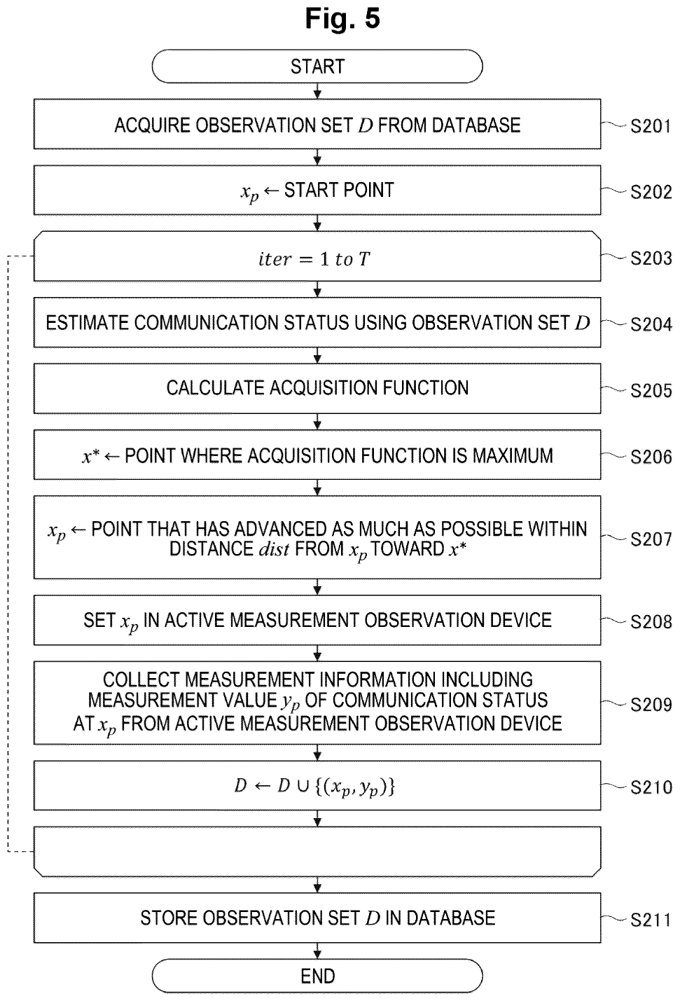

Next, the design of the measurement route and the active measurement process in the first embodiment will be described with reference to FIG. 5. Here, in the present embodiment, a case where a measurement route is designed on the basis of a greedy algorithm and active measurement is performed according to the measurement route will be described. In the design of the measurement route based on the greedy algorithm, the active measurement observation device 30 is sequentially moved as much as possible toward the point where the acquisition function is the highest. However, the estimation of the radio field intensity is recalculated every time the active measurement is performed, and the acquisition function is updated.

The measurement information collecting unit 201 of the communication degradation detection device 10 acquires the passive measurement information stored in the database 206 as an observation set D (S201). Hereinafter, the observation set D is represented as D={(xᵢ, yᵢ)|i=1, . . . , |D|}. Here, xᵢ represents a measurement point included in i-th measurement information, and yᵢ represents radio field intensity at the measurement point xᵢ.

The measurement route design unit 203 of the communication degradation detection device 10 sets the start point in a variable xₚ representing the current measurement point (S202). That is, the measurement route design unit 203 initializes the variable xₚ to the start point. Note that the start point is a predetermined point, and is a point where the active measurement is started.

The communication degradation detection device 10 iterates S204 to S210 T times from iter=1 to iter=T, where “iter” is a variable representing the number of iterations (S203). Hereinafter, S204 to S210 in a certain iteration will be described.

In S204, the communication status estimation unit 202 of the communication degradation detection device 10 estimates the communication status at each position by the Gaussian process using the observation set D. That is, when a variable representing a measurement point is x and a variable representing radio field intensity is y, the communication status estimation unit 202 calculates μ(x) and σ²(x) by a Gaussian process using the observation set D, where y is a random variable y˜N(μ(x), σ²(x)) according to a normal distribution of an average μ(x) and a variance σ²(x). Since the Gaussian process itself is an existing method, a detailed description thereof will be omitted.

In S205, the measurement route design unit 203 of the communication degradation detection device 10 calculates the acquisition function UCB(x) using the average μ(x) and the variance σ²(x) calculated in the above-described S204.

In S206, the measurement route design unit 203 of the communication degradation detection device 10 sets a point x where the acquisition function UCB(x) is maximum as x*.

In S207, the measurement route design unit 203 of the communication degradation detection device 10 sets, as xₚ, a point that has advanced as much as possible within the distance dist from the current measurement point xₚ toward the point x*. Note that the point that has advanced as much as possible is a point that the active measurement observation device 30 can reach, and for example, in a case where the active measurement observation device 30 is a vehicle, the point that the active measurement observation device 30 can reach by traveling on a road or the like.

In S208, the measurement route setting unit 204 of the communication degradation detection device 10 sets the current measurement point xₚ in the active measurement observation device 30. As a result, the radio field intensity yₚ at the measurement point xₚ is measured by the active measurement observation device 30, and the active measurement information including the measurement point xₚ and the radio field intensity yₚ is transmitted to the communication degradation detection device 10.

In S209, the measurement information collecting unit 201 of the communication degradation detection device 10 collects active measurement information including the measurement point xₚ and the radio field intensity yₚ from the active measurement observation device 30.

In S210, the measurement information collecting unit 201 of the communication degradation detection device 10 adds (xₚ, yₚ) to the observation set D.

When the above-described S204 to S210 are repeated T times, the measurement information collecting unit 201 of the communication degradation detection device 10 stores the observation set D in the database 206 (S211). As a result, an observation set D including the passive measurement information and the active measurement information complementing the passive measurement information is obtained. As will be described below, the communication degradation area is detected using the observation set D.

### Design of Measurement Route and Active Measurement Process (Second Embodiment)

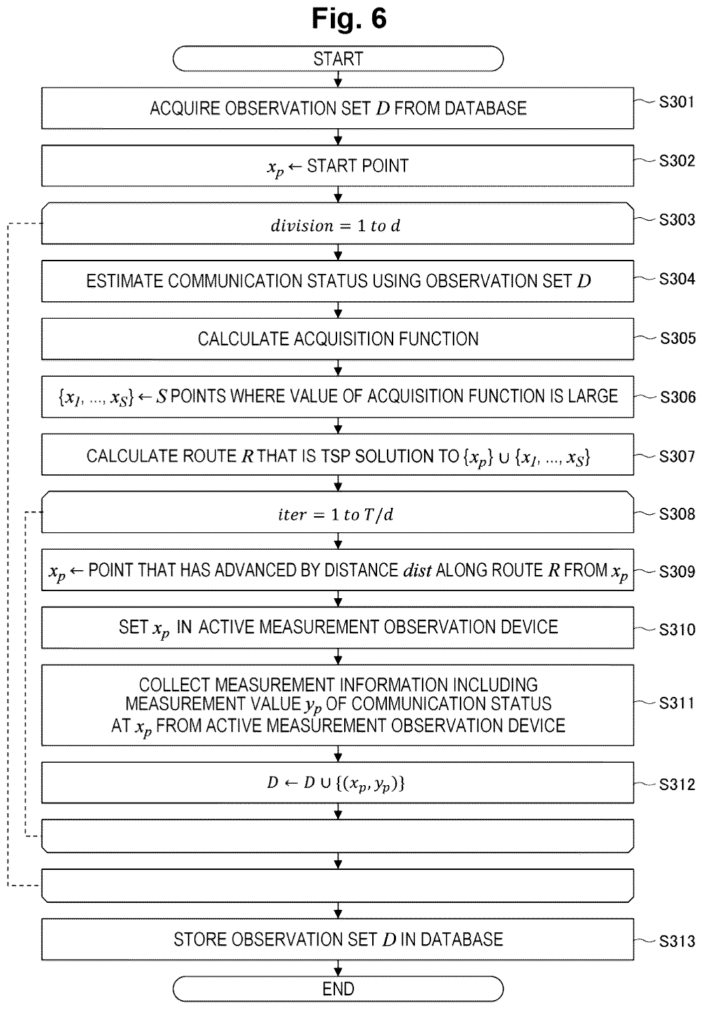

Next, the design of the measurement route and the active measurement process in the second embodiment will be described with reference to FIG. 6. Here, in the present embodiment, a case where a measurement route is designed using the traveling salesman problem (TSP) and active measurement is performed according to the measurement route will be described. In the design of the measurement route using the TSP, T times of the active measurement are divided by d, and estimation of the radio field intensity and redesign of the measurement route are performed for each T/d times of the active measurement. Note that d is a value determined in advance by a user or the like. Hereinafter, for simplicity, it is assumed that T is a multiple of d. Note that, in a case where T is not a multiple of d, for example, “the maximum integer not exceeding T/d” or the like may be appropriately considered instead of “T/d”.

The measurement information collecting unit 201 of the communication degradation detection device 10 acquires the passive measurement information stored in the database 206 as the observation set D (S301). Hereinafter, the observation set D is represented as D={(xᵢ, yᵢ)|i=1, . . . , |D|}. Here, xᵢ represents a measurement point included in i-th measurement information, and yᵢ represents radio field intensity at the measurement point xᵢ.

The measurement route design unit 203 of the communication degradation detection device 10 sets the start point in a variable xₚ representing the current measurement point (S202). That is, the measurement route design unit 203 initializes the variable xₚ to the start point.

The communication degradation detection device 10 sets a variable representing the divisor as “division”, and repeats S304 to S308 d times from division=1 to division=d (S303). Hereinafter, S304 to S308 in a certain repetition will be described.

In S304, the communication status estimation unit 202 of the communication degradation detection device 10 estimates the communication status at each position by the Gaussian process using the observation set D. That is, when a variable representing a measurement point is x and a variable representing radio field intensity is y, the communication status estimation unit 202 calculates μ(x) and σ²(x) by a Gaussian process using the observation set D, where y is a random variable y˜N(μ(x), σ²(x)) according to a normal distribution of an average μ(x) and a variance σ²(x).

In S305, the measurement route design unit 203 of the communication degradation detection device 10 calculates the acquisition function UCB(x) using the average μ(x) and the variance σ²(x) calculated in the above-described S204.

In S306, the measurement route design unit 203 of the communication degradation detection device 10 determines top S points where the value of the acquisition function UCB(x) is large as {x₁, . . . , x_{S}}. This can be obtained, for example, by a gradient method or the like. Note that S is a predetermined value.

In S307, the measurement route design unit 203 of the communication degradation detection device 10 calculates a route R that is the traveling salesman problem solution to {xₚ}∪{x₁, . . . , x_{S}}. As the travel cost of the traveling salesman problem, the distance between points is used. Note that the traveling salesman problem solution may be calculated by a known method.

In S308, the communication degradation detection device 10 iterates S309 to S312 T/d times from iter=1 to iter=T/d, where “iter” is a variable representing the number of iterations. Hereinafter, S309 to S312 in a certain iteration will be described.

In S309, the measurement route design unit 203 of the communication degradation detection device 10 sets a point that has advanced by the distance dist along the route R from the current measurement point xₚ as xₚ.

In S310, the measurement route setting unit 204 of the communication degradation detection device 10 sets the current measurement point xₚ in the active measurement observation device 30. As a result, the radio field intensity yₚ at the measurement point xₚ is measured by the active measurement observation device 30, and the active measurement information including the measurement point xₚ and the radio field intensity yₚ is transmitted to the communication degradation detection device 10.

In S311, the measurement information collecting unit 201 of the communication degradation detection device 10 collects the active measurement information including the measurement point xₚ and the radio field intensity yₚ from the active measurement observation device 30.

In S312, the measurement information collecting unit 201 of the communication degradation detection device 10 adds (xₚ, yₚ) to the observation set D.

When the above-described S304 to S308 are repeated d times, the measurement information collecting unit 201 of the communication degradation detection device 10 stores the observation set D in the database 206 (S313). As a result, an observation set D including the passive measurement information and the active measurement information complementing the passive measurement information is obtained. As will be described below, the communication degradation area is detected using the observation set D.

### <<Communication Degradation Detection Processing>>

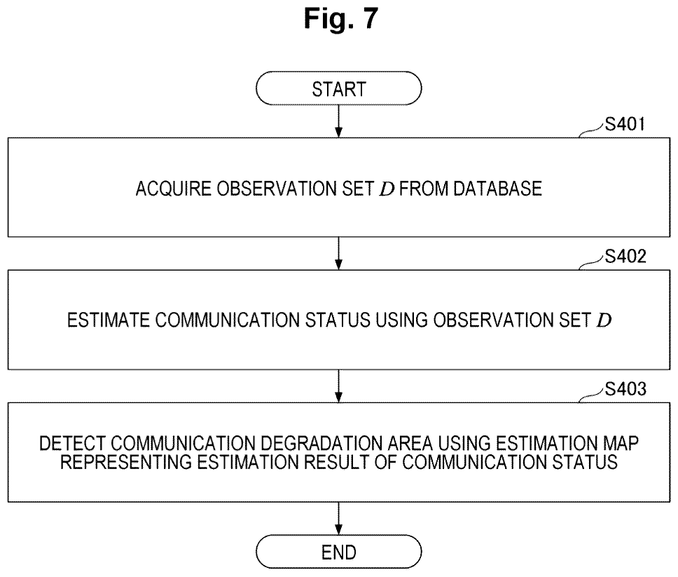

Finally, communication degradation detection processing will be described with reference to FIG. 7. Note that the observation set D includes the passive measurement information and the active measurement information.

The measurement information collecting unit 201 of the communication degradation detection device 10 acquires the observation set D stored in the database 206 (S401).

Next, the communication status estimation unit 202 of the communication degradation detection device 10 estimates the communication status at each position by the Gaussian process using the observation set D (S402). That is, when a variable representing a measurement point is x and a variable representing radio field intensity is y, the communication status estimation unit 202 calculates μ(x) and σ²(x) by a Gaussian process using the observation set D, where y is a random variable y˜N(μ(x), σ²(x)) according to a normal distribution of an average μ(x) and a variance σ²(x). As a result, an estimation map representing the estimation result of the radio field intensity at each position (that is, the distribution of the radio field intensity at each position) is obtained.

Then, the communication degradation detecting unit 205 of the communication degradation detection device 10 detects the communication degradation area by comparing the estimation map obtained in the above-described S402 with the originally expected communication status (S403). That is, the communication degradation detecting unit 205 compares the estimation map with the originally expected communication status, and when the radio field intensity at a certain position in the estimation map is smaller than the radio field intensity indicating the originally expected communication status by more than a threshold, detects the position as the communication degradation area.

### CONCLUSION

As described above, when the passive measurement information is given, the communication degradation detection device 10 according to the present embodiment can perform optimal active measurement while satisfying the constraint conditions related to the active measurement (for example, cost constraints such as the number of times, distance, and the like). This makes it possible to detect communication degradation occurring in a high-density network at low cost. In addition, it is also possible to detect communication degradation occurring in an area with less passive measurement information, and it is possible to reduce the communication degradation area that has been overlooked in the conventional method. Therefore, it is possible to prevent a situation in which local communication degradation that increases due to densification of the network is exacerbated until it becomes fatal degradation, and as a result, service quality can be improved.

The present invention is not limited to the above-mentioned specifically disclosed embodiment, and various modifications and changes, combinations with known technique, and the like can be made without departing from the scope of the claims.

### REFERENCE SIGNS LIST

1 Communication degradation detection system
10 Communication degradation detection device
20 User terminal
30 Active measurement observation device
101 Input device
102 Display device
103 External I/F
103a Recording medium
104 Communication I/F
105 RAM
106 ROM
107 Auxiliary storage device
108 Processor
109 Bus
201 Measurement information collecting unit
202 Communication status estimation unit
203 Measurement route design unit
204 Measurement route setting unit
205 Communication degradation detecting unit
206 Database

1. A measurement route design method, comprising a computer executing:
collecting first measurement information measured by passive measurement;
estimating an estimation map representing a communication status at each position using the first measurement information; and
designing a measurement route of active measurement using the estimation map.

2. The measurement route design method according to claim 1, wherein
in the estimating,
a communication status of each position is estimated by a Gaussian process using the first measurement information, and a result of the estimating is estimated as an estimation map.

3. The measurement route design method according to claim 1, wherein
in the designing,
the measurement route is designed using the estimation map and a predetermined acquisition function, such that a position where the acquisition function is maximized is a measurement position where next active measurement is performed.

4. The measurement route design method according to claim 1, wherein
in the designing,
using the estimation map and a predetermined acquisition function, top predetermined number of positions having a large value of the acquisition function are determined,
a route that travels the predetermined number of positions that are determined and a measurement position of a current active measurement is calculated, as a traveling salesman problem solution, and
the measurement route is designed such that a position reached by moving within a predetermined cost along the route is a measurement position at which next active measurement is performed.

5. The measurement route design method according to claim 1, wherein
in the estimating,
the estimation map is estimated again by further using second measurement information indicating a measurement result of the active measurement according to the measurement route, and
in the designing,
the measurement route is redesigned using the estimation map estimated again.

6. The measurement route design method according to claim 1, further comprising setting the measurement route in a vehicle or an unmanned aerial vehicle that performs the active measurement.

7. A measurement route design apparatus comprising:
a memory; and
a processor coupled to the memory and configured to
collect first measurement information measured by passive measurement,
estimate an estimation map representing a communication status of each position using the first measurement information, and
design a measurement route of active measurement using the estimation map.

8. A non-transitory computer-readable recording medium storing a program for causing a computer to execute the measurement route design method according to claim 1.
